(19) United States
(12) Patent Application Publication
(10) Pub. No.: US 2010/0040705 A1
(43) Pub. Date: Feb. 18, 2010

(54) PEST REPELLENT

(76) Inventors: Koichiro Komai, Kyoto (JP); Nobumitsu Takahashi, Hokkaido (JP); Yasushi Yamagami, Osaka (JP); Osamu Sakurai, Osaka-shi (JP); Michiyo Ichihara, Kyoto (JP); Masayasu Miwata, Kyoto (JP)

Correspondence Address: HARNESS, DICKEY & PIERCE, P.L.C., P.O. BOX 8910, RESTON, VA, 20195, US

(21) Appl. No.: 12/312,716

(22) PCT Filed: Nov. 20, 2007
(86) PCT No.: PCT/JP2007/072483

§ 371 Date: Sep. 28, 2009

(30) Foreign Application Priority Data
Nov. 22, 2006 (JP) 2006-316288

(51) Int. Cl. A01N 65/00

(52) U.S. Cl. 424/725

(57) ABSTRACT

A pest repellent is disclosed having long lasting and high repelling efficacy against sanitary insects such as mosquitoes and which is highly harmless to humans. In at lease one embodiment, the pest repellent contains copaiba oil and/or an extract thereof as well as DEET and/or bisabolol.

### TECHNICAL FIELD

The present invention relates to a pest repellent.

### DESCRIPTION OF THE RELATED ART

### Background Art

Currently, diseases transmitted by noxious organisms, especially blood-sucking pests such as mosquito, black fly, flea, stable fly, tsetse fly, and sand fly, and biting pests such as mite group have increased across the world, and are recognized as highly risky diseases in respect to prevalent areas, case rate, and fatality. For example, mosquito transmits malaria, yellow fever, dengue fever, filariasis, West Nile fever, and the like. Black fly transmits Onchocerciasis and the like. Flea transmits plague, epidemic typhus, and the like. Stable fly transmits Chagas' disease and the like. Trombiculid mite transmits Trombiculiasis. These pests often play a specific role in biologically transmitting pathogens such as virus, rickettsia, bacterium, protozoa and nematode. Biological transmission means that a pest having a pathogen therein by sucking blood of an animal infected with a disease, or ingesting food containing a pathogen, sucks blood of or contacts with a human, livestock such as cow and pig, and pets such as dog again to transmit the pathogen, and the transmission capability thereof is immeasurable. Especially, serious diseases caused by mosquitoes, mites and the like that carry out biological transmission, have become a big problem.

Further, when being attacked by blood-sucking pests or biting pests, itching is felt, rash, dermatitis, and the like, are developed, and damages caused by these pest insects are enormous also in terms of that relatively large amount of blood is lost depending on pests. Damages on livestock are also serious. For example, the number of egg-laying by hens is reduced, and the amount of milk yield by cows is reduced. Therefore, it is highly desired to control against blood-sucking pest insects and biting pest insects. In addition, since flies having no blood-sucking and biting characteristics other than blood sucking flies, such as stable fly, tsetse fly, and sand fly, have no difference in terms of being pests carrying out biological transmission, control against them is also strongly desired. Although a pesticide is generally used for the control against pests, sanitary pests such as blood-sucking pests, biting pests and flies have so many generation sources, high proliferation rate and complicated ecology, and thus complete control by pesticides is extremely difficult. Hence, in order to prevent damage caused by sanitary pests, a repellant is widely used.

Conventionally, as a pest repellent component against blood-sucking pests and biting pests, especially mosquitoes, for example, N,N-diethyltoluamide (hereinafter referred to as “DEET”), p-menthanediol compounds and the like have been known. Among them, the DEET exhibits excellent repellent efficacy against mosquitoes and is formulated for spray formulation, lotion, emulsion, tick formulation and the like having about 10% by weight of active ingredient concentration, and the action thereof works effectively when directly sprayed or applied to skin as needed, thus DEET is widely used. However, DEET has a disadvantage of short duration of repellent efficacy and low aftereffect. In addition, DEET is a chemical synthetic, and problems in terms of safety have been recently pointed out, that neurotic disorders and dermatologic disorders are triggered when used at a high concentration. Hence, as a less toxic pest repellent than the DEET, a mosquito repellent originated from a plant is proposed (for example, refer to Japanese Unexamined Patent Publications JP-A 59-1281319 (1984), JP-A 59-181202 (1984), JP-A 2005-170914, JP-A 2005-97294, JP-A 2004-49601, and JP-A 2004-51564). In addition, it is reported that menthol and citronellal which are monoterpenoids originated from a natural product exhibit repellency against mosquitoes (for example, refer to Japanese Unexamined Patent Publication JP-A 53-86021 (1978) and Inazuka Shinichi Journal of Pesticide Science, 7(2), 145 (1982)). However, a pest repellent component having repellent efficacy equivalent to DEET has yet to be proposed.

### DISCLOSURE OF THE INVENTION

An object of the invention is to provide a pest repellent having long lasting and high repelling efficacy against noxious organisms such as blood-sucking pests, biting pests, and flies other than stable fly, and which is highly harmless to humans.

In order to solve the problem mentioned above, the present inventors have diligently studied ecological behaviors of noxious organisms such as blood-sucking pests, biting pests and flies and repellents, and succeeded in obtaining a pest repellent that exhibits lasting and high repelling efficacy against various noxious organisms by mixing copaiba oil as a natural essential oil and/or an extract thereof with another pest repellent component to thereby complete the invention.

The invention provides a pest repellent containing copaiba oil and/or an extract thereof and another pest repellent component.

Furthermore, in the pest repellent of the invention, it is preferable that the pest repellent component other than copaiba oil and the extract thereof is N,N-diethyltoluamide and/or bisabolol.

Furthermore, in the pest repellent of the invention, it is preferable that a mixing rate of copaiba oil and/or the extract thereof and the other pest repellent component is 50:1 to 1:50 by weight.

Furthermore, in the pest repellent of the invention, it is preferable that the extract of copaiba oil is an extract obtained by extracting from copaiba oil by a steam distillation method.

Furthermore, in the pest repellent of the invention, it is preferable that the extract of copaiba oil is a methanol-insoluble fraction that is obtained by mixing a fraction obtained from copaiba oil by silica gel column chromatography using hexane:chroroforum:ethyl acetate (4:4:1) as a developing and extracting solvent, further with methanol.

Furthermore, in the pest repellent of the invention, it is preferable that the pest repellent is against flying sanitary insects.

### BEST MODE FOR CARRYING OUT THE INVENTION

Hereinafter, preferred embodiments of the invention will be described in detail.

A pest repellent of the invention contains copaiba oil and/or an extract thereof, and another pest repellent component. The pest repellent is effective to various kinds of pest insects, especially to Diptera among them.

Copaiba oil is an oily matter (copaiba oil lecti) having aroma and no color or pale yellow at ambient temperature, which is a so-called essential oil. Copaiba oil is obtained, for example, by distilling copaiba balsam that is a colorless fluent secretion (oleoresin) derived from Copaifera multijuga Hayne (Copaifera L.). Aroma of copaiba oil is derived from oleoresin. Copaifera L. is a plant of pea family produced in northern part of South America, including Brazil, Venezuela, Guyana, Surinam, and Colombia, especially in the Amazon valley and the Orinoco valley, and is a multiply-branched tall tree having a large trunk and smooth bark. Oleoresin is a physiological by-product of Copaifera L. and is accumulated in a lysigenous hollow generated by decomposition of parenchyma cell wall in a stem, or in a separated vascular channel. Oleoresin is extracted by creating a hole reaching to the core of a tree stem of Copaifera L.

By purifying copaiba oil with, for example, a steam distillation method, an extract having a further high concentration of a repellent compound can be obtained. The steam distillation method is different from normal distillation in which a substance to be distilled is directly heated to classify substances by difference in boiling points, and is a method in which a product to be purified is heated with steam supplied. In this method, a product to be purified is indirectly heated by steam in a saturated state within a distillation pot, thus overheating is less likely and there is an advantage that an effective component is difficult to be decomposed or changed in quality. Further, distillation is possible at a far lower temperature than an actual boiling point, thus posing an advantage that components of copaiba oil is difficult to be damaged. In addition, it is preferable to employ not a method of heating water stored in a lower part of a reaction pot to generate steam, but a method of generating steam using an external boiler or the like and supplying this steam to the reaction pot. A flow rate of the steam supplied by this method is higher than a flow rate of raising steam generated by heating the water stored in the lower part, so that a time period in which a component contained in copaiba oil may be subjected to hydrolysis is reduced, and thus, an effective component is far less likely to be decomposed or changed in quality.

Furthermore, the extract of copaiba oil can be obtained by using silica-gel chromatography. For example, first, copaiba oil is treated with silica-gel column chromatography using hexane as a developing and eluting solvent. The residue of copaiba oil after the treatment is treated with silica-gel column chromatography using hexane:chloroform:ethyl acetate (4:4:1) as a developing and extracting solvent to thereby obtain a fraction. Subsequently, the fraction is mixed with methanol to thereby obtain methanol-insoluble fraction of copaiba oil. The methanol-insoluble fraction is also insoluble in water and in ethanol. The methanol-insoluble fraction mainly contains a waxy component of about 700 molecular weight in which terpenes are polycondensed. When the methanol-insoluble fraction is applied to skin, the waxy component forms a layer to prevent a pest repellent component from rapidly volatilizing from the skin surface, and a part of the bonds of the waxy component resulted from polycondensation is broken over time, from which part a pest repellent component volatilizes gradually, so that the pest repellent effect is exerted for long. Accordingly, the methanol-insoluble fraction is especially effective in enhancing the duration of the pest repellent effect.

In the invention, as a pest insect repellent component used in combination with copaiba oil and/or an extract thereof, there may be used the well-known one, without particular limitation. Specific examples thereof include DEET, bisabolol, isopimpinellin, bergaptene, zanthotoxin, kokusagine, dihydrokokusagine, dimethyl terephthalate, diethyl terephthalate, dibutyl phthalate, benzyl benzoate, MGK11, MGK326, dobutrex, indalone, 2-ethyl-1,3-hexanediol, 2-butyl-2-ethyl-1,3-propanediol, dimethyl carbate, propyl mandelate, propyl N,N-diethyl succinamate, benzamide, o-chloro-N,N-diethylbenzamide, isobornyl thiocyanoacetate, phenyl salicylate, benzyl salicylate, dibutyl sebacate, paradichlorobenzene, and candeia oil. Among them, DEET, bisabolol, candeia oil and the like are preferable. Bisabolol is obtained, for example, by extraction from candeia oil, chamomile oil, lavender oil and the like. In addition, bisabolol can be chemically synthesized. Bisabolol is widely used for cosmetics and the like for moisture-retaining, antimicrobial, antiinflammatory, analgesic actions, and the like. Further, it is known that chamomile oil, lavender oil and the like that contain bisabolol have repellent efficacy against pests such as mosquitoes. One of pest repellent components may be used alone or two or more of them may be used in combination.

A usage ratio of copaiba oil and/or an extract thereof to another pest repellent component is not particularly limited, but preferably a ratio by weight of 50:1 to 1:50 is adopted. When the other pest repellent component is DEET, the ratio of copaiba oil and/or the extract thereof:DEET (ratio by weight) is more preferably 5:1 to 1:50, still more preferably 2:1 to 1:20, especially preferably 1:1 to 1:10. When the other pest repellent component is bisabolol, the ratio of copaiba oil and/or the extract thereof:bisabolol (ratio by weight) is more preferably 50:1 to 1:10, still more preferably 20:1 to 1:5, especially preferably 10:1 to 1:2. By using copaiba oil and/or the extract thereof and another pest repellent component at the aforementioned ratio, it is possible to obtain a pest repellent that exhibits sufficient repellent efficacy against pests and whose repellent efficacy is maintained in a high level over a long time. When the content of copaiba oil and/or the extract thereof is less than the above ratio, there is a risk of lowering duration of repellent efficacy. On the other hand, when the content of copaiba oil and/or extract thereof is more than the above ratio, combination effect with another pest repellent component is likely to decrease.

The pest repellent of the invention may contain one or two or more of components selected from an insecticidal component, a natural component, plant essential oil and the like. Examples of the insecticidal component include pyrethroids, such as pyrethrin, cinerin, jasmoline, allethrin, phthalthrin, resmethrin, furamethrin, phenothrin, permethrin, imiprothrin, cyphenothrin, tralomethrin, etofenprox, prallethrin, cyfluthrin, silafluofen, bifenthrin, fulmethrin, fluvalinate, deltamethrin, empenthrin, metofluthrin, transfluthrin.

Among them, in view of long-term duration of the effect and improvement of insecticidity by combination use with copaiba oil, empenthrin, pyrethrin, imiprothrin, prallethrin, metofluthrin, transfluthrin and the like are preferable. One of insecticidal components can be used alone or two or more of them can be used in combination.

As the natural component, a natural component having pest repellent efficacy, insecticidal efficacy and the like is preferable, and examples thereof include, p-menthane-8-ene-1,2-diol, carane-3,4-diol, p-menthane-3,8-diol, 2,3,4,5-bis(A2-butylene)tetrahydrofurfural, di-n-propylisocinchomeronate, di-n-butylsuccinate, 2-hydroxyoctylsulfide, (N-carbo-sec-butyloxy)-2-(2′-hydroxyethyl)-piperidine, α-pinene, geraniol, citronellal, camphor, linalool, and kadinol. Among them, in view of mutual complement of fast-acting properties of the natural component and sustainability of the pest repellent of the invention, p-menthane-8-ene-1,2-diol, p-menthane-3,8-diol, citronellal and the like are preferable. One of natural components can be used alone or two or more of them can be used in combination. Examples of the plant essential oil include oils obtained from tea tree, pine, cypress, camphor tree, false arborvitae, citronella, rose, geranium, cedar wood, lavender, anise, spearmint, nutmeg, peppermint, cinnamon, clove, eucalyptus, garlic, marjoram, palmarosa, cumin, coriander, origanum, mint, lemon peel, rosemary, and hyssop. One of plant essential oils can be used alone or two or more of them can be used in combination. There is no limitation to the usage amount of the insecticidal component, the natural component and the plant essential oil, as long as it is in a range where effect of the pest repellent of the invention is not impair, for example, the usage ratio of (copaiba oil and/or the extract thereof):(total amount of another pest repellent component, insecticidal component, natural component and plant essential oil) is preferably 50:1 to 1:50 by weight.

When the pest repellent of the invention is used, according to the purpose of use, an active ingredient mixture of copaiba oil and/or the extract thereof, another pest repellent component, an insecticidal component, a natural component, plant essential oil, and the like, as necessary, can be used as they are. Further, for the sake of convenience on use, for promotion or stabilization of the repellent efficacy, and for adaptation to an applied method, an auxiliary is added to the active ingredient mixture to formulate into various forms, such as lotion, emulsion, oily agent, cream, aerosol formulation, granules, resin, and soap. For example, the active ingredient mixture is dissolved or dispersed in alcohol and obtained solution or dispersion liquid is applicable directly by dispersion of the pest repellent to a required area.

As the auxiliary, any auxiliary commonly used in the field can be used, and examples thereof include carriers (liquid diluent or solid diluent), and surfactant. Among carriers, examples of the liquid diluent include aromatic hydrocarbons such as toluene, xylene, and methylnaphthalene, alcohols such as isopropanol, and glycol, esters such as butyl acetate, ketones such as cyclohexanone, amides such as dimethylformamide, sulfoxides such as dimethylsulfoxide, cellosolves such as ethylcellosolve, petroleum fractions such as kerosene, ethers such as dibutyl ether, chlorinated hydrocarbons such as chlorobenzene, vegetable and animal oil, fatty acids and esters thereof, and water. One of liquid diluents can be used alone or two or more of them can be used in combination. Among carriers, examples of the solid diluent include clay, caryone, talc, diatomaceous earth, silica, calcium carbonate, montmorillonite, bentonite, feldspar, quarts, and alumina. One of solid diluents can be used alone or two or more of them can be used in combination.

The surfactant is used for spreading agent, emulsifier, wetting agent, dispersing agent, disintegrating agent and the like. Specific examples thereof include cationic surfactants, anionic surfactants, noionic surfactants and amphoteric surfactants, such as stearyltrimethylammonium chloride, sodium lignosulfonate, sodium naphthalenesulfonate, formalin condensate, polyoxyethylene alkyl phenyl ether, polyoxyethylene alkyl ether, and lauryl betaine. Further, vegetable oil such as castor oil, olive oil, palm oil, and copra oil, long chain aliphatic alcohols such as octanol and octadecanol, chemical compounds containing a benzene ring such as benzyl benzoate and benzyl salicylate, and glycols such as polyethylene glycol, propylene glycol, BDG, PFDG, butyl glycol, HeDG, and DEDG, and the like can be preferably used. Furthermore, long chain alcohols such as cetyl alcohol, stearyl alcohol, and behenyl alcohol, long chain aliphatic esters such as 2-hexyldecyl isostearate, isopropyl myristate, diethyl sebacate, dibutyl sebacate, and isopropyl sebacate, aromatic compounds such as diethyl phthalate, di(2-ethylhexyl) phthalate, phenyl glycol, and phenyl diglycol, vegetable oil series surfactants such as solbitan oleate and castor oil polyoxyethylene ether, paraffin-based organic solvents, and the like can be more preferably used. One of surfactants can be used alone or two or more of them can be used in combination.

Various formulations obtained using these auxiliaries may be used as they are or used in a state of being diluted with an appropriate solvent such as water to a desired concentration in actual usage. The formulation can contain 30 to 95% by weight of water based on the total amount of the formulation. An electric conductivity of water is not particularly limited, but it is preferably 250 μS/cm or below, more preferably 50 μS/cm or below, especially preferably 10 μS/cm or below. When the level of 250 μS/cm is exceeded, there is a risk of decomposition of the active ingredient due to precipitation and putrefaction and the like over a long-term preservation.

A content of an active ingredient mixture in the pest repellent of the invention can be, without particular limitation, selected as appropriate from a wide range depending on a form of formulation, an application method and the like, and, for example, when used as a liquid agent such as lotion and aerosol and a cream agent, or when used by impregnating into a base material, the content is preferably 0.01 to 50% by weight, more preferably 0.1 to 30% by weight, especially preferably 0.5 to 10% by weight, based on the total amount of the formulation. In addition, when used as aerosol, the content of a propellant is, without particular limitation, preferably 60 to 90% by weight, more preferably 80% by weight. Examples of the propellant include liquefied petroleum gas (hereinafter referred to as “LPG”) and dimethyl ether (hereinafter referred to as “DME”). Further, as liquid for the aerosol, a solution where an active ingredient mixture is dissolved in alcohols, paraffin-based organic solvents, or the like is preferable. Among alcohols or the paraffin-based organic solvents, ethanol is preferable in view of odor. The content of the active ingredient mixture in liquid for aerosol is preferably 10 to 40% by weight, more preferably 20 to 30% by weight, based on the total amount of liquid for aerosol. The content of copaiba oil and the extract thereof in liquid for aerosol is preferably 1 to 20% by weight, more preferably 5 to 10% by weight, based on the total amount of liquid for aerosol. Although precipitation is formed when copaiba oil is added to ethanol, by mixing with propellant such as LPG and DME and pressurizing, dissolution can be achieved without precipitation.

Further, although a treatment amount of the pest repellent of the invention can be selected as appropriate from a wide range, depending on a formulation type, a target pest group, the density, time for use, climatic conditions, a user's age, and the like, for reference, the content of the active ingredient mixture (a mixture of copaiba oil and/or the extract thereof, another pest repellent component, and an insecticidal component, a natural component and plant essential oil mixed as needed) is generally 0.01 to 2 mg, preferably 0.05 to 1 mg, based on an area of 1 cm² of skin. The amount is applicable to cases where the active ingredients mixture is used directly without mixing an auxiliary therewith.

When the pest repellent of the invention is applied to a human, for example, a cream agent, a lotion agent, or the like may be directly applied, or an aerosol agent, an aqueous agent, or the like may be sprayed, to an exposed portion of skin such as arms and neck. In addition, when not applying directly to skin, using an appropriate auxiliary depending on an application place, a target pest to repel, an application method and the like, the pest repellent may be used with an appropriate active ingredient concentration. Further, when the pest repellent of the invention is sprayed to or impregnated into fabric made of natural material, synthesized material and the like, knitting, non-woven fabric, leather, felt, a sheet-like object such as paper and the like, a pest repellent sheet is obtained, which is applicable for repelling pest in a kitchen, a wardrobe and the like. Further, when applied to pets and the like, the pest repellent of the invention may be used in a state of being kneaded or impregnated into a resin collar.

The pest repellent of the invention can be applied for practical use in various purposes and forms, such as fiber, leather, wood, building material, coating/adhesive, plastic/film, daily product, electric appliances, paper/pulp, oil agent, and food. Examples thereof are as follows. In a microcapsule form using melamine, urethane, gelatin, silica and the like as an encapsulated agent, a form carried by an inorganic substance such as silica gel and zeolite, a form included in cyclodextrin or a layered inorganic compound, or a form of solution, the pest repellent of the invention is attached to fiber such as polyester, polyamide, polyurethane, polyvinylidene chloride, polyvinyl chloride, rayon, cupra, cotton, linen, and silk, to thereby obtain a pest-repelling fiber product. For example, when applied to hosiery, it is possible to effectively prevent legs from being attached by mosquitoes. It is also effective to apply to a bed net.

Furthermore, it is also possible to obtain a pest-repelling fiber product when the pest repellent of the invention is mixed in fiber in a spinning process of the fiber. For example, it is possible to knead the pest repellent of the invention in a spinning process of a synthetic fiber such as polyester and polyamide, or to mix the pest repellent of the invention with a spinning dope in dry-spinning of polyurethane and the like and in wet-spinning of rayon, cupra and the like. Furthermore, when the pest repellent of the invention is added to coating, a coating layer can obtain pest repellency. When applied to a film or resin such as polyethylene, polypropylene, polyvinyl chloride, polyvinylidene chloride, cellophane, polyester and polyamide, the pest repelling efficacy can be added thereto.

When the pest repellent of the invention impregnated into a gel-like material and the like is placed in a living room, a bathroom, a toilette and the like, a pest-repelling atmosphere can be obtained. Purposes and usage forms of the pest repellent of the invention are not limited to the aforementioned examples, and besides, there also exist various purposes and usage forms for use.

The pest repellent of the invention is used for repelling various kinds of insects. Among the various insects, it is especially effective to sanitary insects. Examples of the sanitary insects include blood-sucking sanitary insects and biting sanitary insects such as mosquito, black fly, horsefly, stable fly, tsetse fly, sand fly, flea, cimex and tick, and non-blood-sucking sanitary insects such as cockroach, fly, small fly, and Chironomidae. Note that, the non-blood-sucking insects are also a small type of Diptera. Among them, it is effective to flying sanitary insects, especially to mosquito.

Examples of mosquito include Anopheles, Mimomyia, Culiseta, Orthopodomyia, Mansonia, Culex, Heizmannia, Aedes, Armigeres, Uranotaenia, Tripteroides, Topomyia, Malaya, and Toxorhynchite. Among them, when used against Anopheles, Culex, Aedes, Armigeres or the like, that encounter people very frequently, it is useful because repellent efficacy is exerted more reliably. As a specific type of such mosquito, an example of the Anopheles includes anopheles sinesis wiedemann. Examples of the Culex include Culex quinquefasciatus, Culex pipiens pallens, Culex pipiens molestus, and Culex tritaeniorhynchus. Examples of the Aedes include Aedes albopictus and Aedes aegypti. An example of the Armigeres includes Armigeres subalbatus. Further, examples of Chironomidae, Chironomus circumdatus, Chironomus kiiensis, Nippo-Yusurika (family Chironomidae sp.), Chironomours plumosus, Chironomus salinarius, Chironomus samoensis, Chironomus yoshimatsui, Biwakanbuto-Yusurika (family Chironomidae sp.), Kuroguributo-Yusurika (family Chironomidae sp.), Ureshino-Yusurika (family Chironomidae sp.), Polypedilum nubifer, Tanytarsus oyamai, Propsilocerus akamusi, Polypedilum kyotoense, and Cricotopus bicinctus. Examples of a midge fly include Psychodidae, Drosophilida, Phoridae, Cecidomyiidae, Sciaridae, Mycetophilidae, Scatopsidae, Sphaeroceridae, Chloropidae, Agromyzidae, Bibionidae, Tipulidae, Piophilidae, Sepsidae, Dolichopodidae, and biting midge.

### EXAMPLES

The invention will hereinafter be described specifically with reference to a reference example, examples, comparative examples and test examples.

### Examples 1 to 6 and comparative examples 1 to 6

Pest repellent components (copaiba oil, DEET, Bisabolol and candeia essential oil) were weighed in a ratio (mg) shown in table 1, dissolved in chloroform, and adjusted to be 100 ml in total, and thereby pest repellents of the invention and of comparatives were produced.

### Test Example 1

### Repellent Efficacy Test Against Mosquito

Cotton clothes (shirting) of 10 cm by 10 cm were impregnated into each 2 ml of the pest repellents of examples 1 to 6 and comparative examples 1 to 6 and dried in a room for 2 hours to thereby produce specimens for the test. Each of the specimens for the test was cut into a size of 6 cm by 6 cm and attached to a hole of 5 cm by 5 cm formed on a back side of a nitrile glove from the inner side. The nitrile glove was put on a hand, which was put into a cage having test insects therein for 5 minutes while making a first, followed by counting the number of insects coming fly to suck blood on the specimen for the test within the time. This operation was repeated 3 times with different cages for each specimen and an average of repelling rates (%) was obtained. Note that, coming fly means a state where wings are furled to stop or to walk. Moreover, sucking blood means a state of being stopped while inserting a proboscis into the test specimen. Table 1 shows the result.

As the test insect, 150 pieces of pupas of successively bred Aedes albopictus were placed on a deep Petri dish and were emerged in a net type cage of 30 cm by 30 cm by 30 cm, which were bred only with 2% of sugar water for ten days after the emergence, and imagoes made in a state of starving for blood-sucking were used.

TABLE 1

| | | Pest repellent (mg) | | | | Repellent efficacy (%) | |
|---|---|---|---|---|---|---|---|
| | | Copaiba oil | DEET | Bisabolol | Candeia oil | Come fly | Blood-sucking |
| Example | 1 | 50 | 50 | — | — | 91.7 | 100.0 |
| | 2 | 25 | 50 | — | — | 78.0 | 71.4 |
| | 3 | 50 | — | 50 | — | 95.1 | 94.3 |
| | 4 | 50 | — | 25 | — | 89.9 | 90.4 |
| | 5 | 50 | — | 10 | — | 72.3 | 75.6 |
| | 6 | 25 | — | 25 | — | 86.2 | 88.0 |
| Comparative | 1 | — | 250 | — | — | 87.7 | 94.3 |
| Example | 2 | — | 50 | — | — | 42.4 | 47.5 |
| | 3 | 50 | — | — | — | 62.5 | 57.1 |
| | 4 | — | — | 50 | — | 36.4 | 38.1 |
| | 5 | — | — | 250 | — | 85.5 | 81.5 |
| | 6 | — | — | — | 250 | 23.6 | −5.6 |

### Test Example 2

### Repellent Efficacy Test Against Small Fly

Cotton clothes (shirting) of 10 cm by 10 cm were impregnated into each 2 ml of the pest repellents of examples 1 and 4 and comparative examples 2 to 3 and dried in a room for 2 hours to thereby produce specimens (treated clothes) for the test. A hole of 1 cm diameter was formed at the center of an acrylic pipe which is 2 cm in diameter and 10 cm long, and one end of the pipe was closed with the specimen for the test, whereas the other end was closed with a cloth (untreated cloth) of 10 cm by 10 cm that was not impregnated into the pest repellent.

Adult Tinearia alternata (test insect) captured outside and bred in a laboratory were put into the acrylic pipe from the hole at the center of the acrylic pipeand the hole was closed, and it was left for an hour under conditions of complete darkness. One hour later, it is observed that on which side the test insects were from the center of the acrylic pipe. The test was repeated 10 times. Table 2 shows the result.

TABLE 2

| | Landing Number | Repelling |
|---|---|---|
| | Treated Cloth/Non-treated cloth | rate (%) |
| Example 1 | 0/10 | 100.0 |
| Example 4 | 1/9 | 80.0 |
| Comparative Example 2 | 4/6 | 20.0 |
| Comparative Example 3 | 4/6 | 20.0 |
| Comparative Example 4 | 5/5 | 0.0 |

### Test Example 3

### Repellent Efficacy Test Against Chironomidae

The test was conducted in the similar manner to the test example 2 except that adult Chironomidae was used in place of adult Tinearia alternata as a test insect. Table shows the result.

TABLE 3

| | Landing Number | Repelling |
|---|---|---|
| | Treated Cloth/Non-treated cloth | rate (%) |
| Example 1 | 1/9 | 100.0 |
| Example 4 | 1/9 | 80.0 |
| Comparative Example 2 | 6/4 | −20.0 |
| Comparative Example 3 | 4/6 | 20.0 |
| Comparative Example 4 | 5/5 | 0.0 |

### Example 7

To prepare a pest repellent solution, 1 part by weight of copaiba oil and 1 part by weight of DEET were dissolved in a mixed solvent of 68 parts by weight of ethanol and 30 parts by weight of a paraffin-based solvent (product name: IP Solvent, manufactured by Idemitsu Kosan., K.K.) to thereby prepare a pest repellent solution. 20 parts by weight of the pest repellent solution was filled in an aerosol container, and further 80 parts by weight of LPG (propellant) was filled with pressure to thereby prepare the pest repellent of the invention in a form of an aerosol formulation. The product pressure was 0.22 MPa.

### Example 8

The pest repellent of the invention in a form of an aerosol formulation was prepared in the similar manner to the example 7 except that 1 part by weight of bisabolol was used in place of 1 part by weight of DEET.

### Example 9

1 part by weight of copaiba oil and 0.1 part by weight of bisabolol were dissolved in a mixture containing 93.9 parts by weight of water having 10 μS/cm of electric conductivity and 5 parts by weight of a nonionic surfactant (Product name: Newcol 565SC, manufactured by Nippon Nyukazai Co., Ltd.) to thereby prepare the pest repellent of the invention in a form of an aqueous formulation.

### Comparative Example 7

The pest repellent for comparison in a form of an aerosol formulation was prepared in the similar manner to example 7 except that 2 parts by weight of DEET was used in place of 1 part by weight of copaiba oil and 1 part by weight of DEET.

### Comparative Example 8

The pest repellent for comparison in a form of an aerosol formulation was prepared in the similar manner to example 7 except that 2 parts by weight of copaiba oil was used in place of 1 part by weight of copaiba oil and 1 part by weight of DEET.

### Comparative Example 9

An aqueous formulation of the pest repellent was prepared for comparison in the same manner as example 9 except that 1.1 parts by weight of DEET was employed in place of 1 part by weight of copaiba oil and 0.1 part by weight of bisabolol.

### Test Example 4

### Repellent Efficacy Test by Spraying

After each of the pest repellents of examples 7 to 9 and comparative examples 7 to 9 was sprayed for 10 seconds for each hand, both hands were put into a cage having 50 pieces of female adult Aedes albopictus therein for 5 minutes, followed by counting the number of insects coming fly to both hands. The same tests were conducted 2 hours later and 4 hours later. Note that, the pest repellents in the form of aqueous formulation of example 9 and comparative example 9 were filled in a spraying device to be sprayed. Table 4 shows the result.

TABLE 4

| | Come fly Number (pcs) | | |
|---|---|---|---|
| | 0 | 2 | 4 |
| | hr later | hrs later | hrs later |
| Example 7 | 2 | 3 | 10 |
| Example 8 | 2 | 4 | 11 |
| Example 9 | 2 | 4 | 5 |
| Comparative Example 7 | 17 | 25 | 39 |
| Comparative Example 8 | 15 | 17 | 21 |
| Comparative Example 9 | 13 | 16 | 21 |

### Test Example 5

Each of the pest repellents of example 9 and comparative example 9 was sprayed once to each cotton cloth of 6 cm by 6 cm from a position of 10 cm high, and left at a room temperature for 1 hour and for 5 hours. Each cloth was attached to a hole of 5 cm by 5 cm formed on a back side of a nitrile glove from the inner side. The nitrile glove was put on a hand, which was put into a cage having 50 pieces of female adult Aedes albopictus therein for 5 minutes while making a first, followed by counting the number of insects coming fly within the time to calculate the repelling rate. Table 5 shows the result.

TABLE 5

Repelling rate (%)

| | Example 9 | Comparative Example 9 |
|---|---|---|
| 1 hr later | 92.0 | 45.1 |
| 5 hrs later | 75.2 | 28.5 |

### Test Example 6

### Test for Solubility of Pest Repellent

5 parts by weight of a mixture of copaiba oil and DEET or bisabolol was mixed with 95 parts by weight of various solvents to visually observe solubility. Evaluation was such that a state where neither separation nor precipitation occurs after preservation at a room temperature for one week is regarded as “well-soluble”, and a state where neither separation nor precipitation occurs right after mixing, but separation and precipitation occur after preservation at a room temperature for one week is regarded as “soluble”. “Well-soluble solvents” were octanol, octyldodecanol, 2-hexyldodecyl isostearate, isopropyl myristate, oleic acid, diethyl sebacate, diethyl phthalate, di(2-ethylhexyl) phthalate, benzyl alcohol, benzyl benzoate, benzyl salicylate, dodecylbenzene, ricinus, palm oil, copra oil, cetyl alcohol, stearyl alcohol, behenyl alcohol, pyridine, dichloromethane, chloroform, dimethylsulfoxide, benzene, toluene, xylene, quinoline, methylnaphthalene and diisopropylnaphthalene. “Soluble solvents” were phenyl glycol, phenyl diglycol, olive oil, almond oil, colza and soybean oil.

### Reference Example 1

### Formulation of Copaiba Oil Extract

100 g of copaiba oil was treated with silica-gel column chromatography (silica-gel for filling, product name: BW-127ZH, 350 g) using 3 liter of hexane as a developing and extracting solvent. Subsequently, the residue of copaiba oil after the treatment with the silica-gel column chromatography was treated with a silica-gel column chromatography (product name: BW-127ZH, 350 g) using 2.4 liter of hexane:chloroform:ethyl acetate (4:4:1) as a developing and extracting solvent to thereby obtain a fraction. When 5.0 g of the fraction was mixed with 50 g of methanol, white supernatant was formed, which was removed by filtration. The operation was repeated 3 times to obtain an extract of copaiba oil as a methanol-insoluble fraction.

The main physical properties of the methanol-insoluble fraction are as follows.

1) Solvent solubility: Insoluble in water, methanol and ethanol. Soluble in chloroform and hexane. Hardly soluble in ethyl acetate and acetone. Note that, solubility in organic solvents was checked at 25° C. in all cases.
2) Molecular weight:

Mass spectrum (FAB−MS)=m/z 784 (M⁺).

Note that, ionization of the methanol-insoluble fraction was carried out in accordance with an EI (Electron Ionization) method. Mass spectrum was measured using glycerol as matrix at 20° C. with mass spectrometer (product name: JMS-NS700 type, manufactured by JEOL Ltd.)
3) Infrared absorption spectrum (Thin film method); v max (cm⁻¹); 2950 (s, C—H), 1450 (m, C—H), 1380 (m), 1220 (m), 720 (s).
Note that, the infrared absorption spectrum was measured at 25° C. using Fourier transform infrared spectrophotometer (product name: FTIR-8200D type, manufactured by SHIMADZU CORPORATION).

### Example 10

The pest repellent of the invention was produced in the similar manner to example 1 except that the extract of copaiba oil obtained at reference example 1 was used. As to the pest repellent, when a repelling rate (%) relative to coming fly and blood sucking of mosquito was checked similarly to test example 1, the pest repellent exhibited much higher repelling rate (%) than the pest repellent of example 1 did in terms of coming fly, and was equivalent to the pest repellent of example 1 in terms of blood sucking. Further, compared to the pest repellent of the invention of example 1, duration of the repellent efficacy was extended.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

The pest repellent has high pest repellent efficacy, whose repelling efficacy is kept over a long time, and further has high safety to a human. Furthermore, sufficient repellent efficacy is exhibited only with a smaller amount than DEET, thus safety to a human is much higher, compared to a case of applying DEET. It is also useful in terms of exhibiting the repellent efficacy against many sanitary pest insects.

1. A pest repellent containing copaiba oil and/or an extract thereof and another pest repellent component.

2. The pest repellent of claim 1, wherein the pest repellent component other than copaiba oil and the extract thereof is N,N-diethyltoluamide and/or bisabolol.

3. The pest repellent of claim 1, wherein a mixing rate of copaiba oil and/or the extract thereof and the other pest repellent component is 50:1 to 1:50 by weight.

4. The pest repellent of claim 1, wherein the extract of copaiba oil is an extract obtained by extracting from copaiba oil by a steam distillation method.

5. The pest repellent of claim 1, wherein the extract of copaiba oil is a methanol-insoluble fraction that is obtained by mixing a fraction obtained from copaiba oil by silica gel column chromatography using hexane:chroroforum:ethyl acetate (4:4:1) as a developing and extracting solvent, further with methanol.

6. The pest repellent of claim 1, wherein the pest repellent is against flying sanitary insects.

7. The pest repellent of claim 2, wherein a mixing rate of copaiba oil and/or the extract thereof and the other pest repellent component is 50:1 to 1:50 by weight.

8. The pest repellent of claim 2, wherein the extract of copaiba oil is an extract obtained by extracting from copaiba oil by a steam distillation method.

9. The pest repellent of claim 3, wherein the extract of copaiba oil is an extract obtained by extracting from copaiba oil by a steam distillation method.

10. The pest repellent of claim 2, wherein the extract of copaiba oil is a methanol-insoluble fraction that is obtained by mixing a fraction obtained from copaiba oil by silica gel column chromatography using hexane:chroroforum:ethyl acetate (4:4:1) as a developing and extracting solvent, further with methanol.

11. The pest repellent of claim 3, wherein the extract of copaiba oil is a methanol-insoluble fraction that is obtained by using a fraction obtained from copaiba oil by silica gel column chromatography using hexane:chroroforum:ethyl acetate (4:4:1) as a developing and extracting solvent, further with methanol.

12. The pest repellent of claim 2, wherein the pest repellent is against flying sanitary insects.

13. The pest repellent of claim 3, wherein the pest repellent is against flying sanitary insects.

14. The pest repellent of claim 4, wherein the pest repellent is against flying sanitary insects.

15. The pest repellent of claim 5, wherein the pest repellent is against flying sanitary insects.
